(19) United States
(12) Patent Application Publication
(10) Pub. No.: US 2025/0285266 A1
(43) Pub. Date: Sep. 11, 2025

(54) FLEXIBLE TRANSFORMER FOR MULTIPLE HETEROGENEOUS IMAGE INPUT FOR MEDICAL IMAGING ANALYSIS

(71) Applicant: Siemens Healthineers AG, Forchheim (DE)

(72) Inventors: Gengyan Zhao, Robbinsville, NJ (US); Badhan Kumar Das, Erlangen (DE); Boris Mailhe, Plainsboro, NJ (US); Youngjin Yoo, Princeton, NJ (US); Eli Gibson, Lawrenceville, NJ (US); Dorin Comaniciu, Princeton, NJ (US)

(21) Appl. No.: 18/961,662

(22) Filed: Nov. 27, 2024

Related U.S. Application Data
(60) Provisional application No. 63/561,959, filed on Mar. 6, 2024.

(51) Int. Cl. G06T 7/00; G06V 10/77; G06V 10/82

(52) U.S. Cl. CPC G06T 7/0012; G06V 10/7715; G06V 10/82; G06T 2207/20084

(57) ABSTRACT

Systems and methods for performing a medical imaging analysis task are provided. 1) a plurality of medical images acquired at a plurality of acquisition orientations and in one or more domains and 2) a domain code for each particular acquisition orientation of the plurality of acquisition orientations are received. Each of the domain codes identify a presence of the one or more domains of the plurality of medical images that were acquired at the particular acquisition orientation. For each of the particular acquisition orientations, the domain code for the particular acquisition orientation are encoded, features are extracted from the plurality of medical images that were acquired at the particular acquisition orientation, and the encoded domain code and the extracted features are combined to generate image features for the particular acquisition orientation. A medical imaging analysis task is performed based on the image features for each of the particular acquisition orientations. Results of the medical imaging analysis task are output.

### CROSS-REFERENCE TO RELATED APPLICATIONS

This application claims the benefit of U.S. Provisional Application No. 63/561,959, filed Mar. 6, 2024, the disclosure of which is herein incorporated by reference in its entirety.

### TECHNICAL FIELD

The present invention relates generally to AI/ML (artificial intelligence/machine learning) based medical imaging analysis, and in particular to a flexible transformer for multiple heterogeneous image input for medical imaging analysis.

### BACKGROUND

In medical imaging, the acquisition of medical images often entails diverse protocols across various clinical sites, resulting in significant cross-patient and in-patient heterogeneity within medical imaging datasets. Notably, in MRI (magnetic resonance imaging) acquisition, a single imaging session typically yields multiple 3D images characterized by multiple contrasts, different acquisition orientations, and varying anisotropic resolutions. Such broad heterogeneity in medical imaging datasets introduces complexity in utilizing these images for analysis using neural networks. Conventional approaches for medical imaging analysis using neural networks typically involve resampling or resizing images to uniform resolutions or sizes. However, such conventional approaches risk information loss, particularly for anisotropic images with different orientations. In addition, preprocessing pipelines for resampling or resizing images for each clinical application typically increases development costs.

### BRIEF SUMMARY OF THE INVENTION

In accordance with one or more embodiments, systems and methods for performing a medical imaging analysis task are provided. 1) a plurality of medical images acquired at a plurality of acquisition orientations and in one or more domains and 2) a domain code for each particular acquisition orientation of the plurality of acquisition orientations are received. Each of the domain codes identify a presence of the one or more domains of the plurality of medical images that were acquired at the particular acquisition orientation. For each of the particular acquisition orientations, the domain code for the particular acquisition orientation are encoded, features are extracted from the plurality of medical images that were acquired at the particular acquisition orientation, and the encoded domain code and the extracted features are combined to generate image features for the particular acquisition orientation. A medical imaging analysis task is performed based on the image features for each of the particular acquisition orientations. Results of the medical imaging analysis task are output.

In one embodiment, a first set of features is extracted from the input tensor of that acquisition orientation using a first machine learning based encoder. The first set of features are encoded into a second set of features using a second machine learning based encoder to generate the extracted features. In one embodiment, the first set of features is encoded with positional embeddings. In one embodiment, the first set of features are lower level features and the second set of features are higher level features.

In one embodiment, the plurality of medical images that were acquired at the particular acquisition orientation is resampled onto a same pixel grid for that particular acquisition orientation to form aligned images. The aligned images are combined to form an input tensor. The first set of features is extracted from the input tensor using the first machine learning based encoder.

In one embodiment, the encoded domain code and the extracted features are combined using a cross-attention layer.

In one embodiment, the image features for each of the particular acquisition orientations are combined to generate combined features. The medical imaging analysis task is performed based on the combined features.

In one embodiment, each of the domain codes identify an absence of certain domains of a set of predefined domains from the one or more domains of the plurality of medical images that were acquired at the particular acquisition orientation.

In one embodiment, the plurality of acquisition orientations comprises at least one of axial, sagittal, or coronal.

These and other advantages of the invention will be apparent to those of ordinary skill in the art by reference to the following detailed description and the accompanying drawings.

### BRIEF DESCRIPTION OF THE DRAWINGS

FIG. 1 shows a method for assessing for performing a medical imaging analysis task on a plurality of medical images acquired at a plurality of acquisition orientations, in accordance with one or more embodiments;

FIG. 2 shows a network architecture of a transformer for performing a medical imaging analysis task on a plurality of medical images acquired at a plurality of acquisition orientations, in accordance with one or more embodiments;

FIG. 3 shows a table comparing performance of the transformer model in accordance with embodiments described herein with conventional models;

FIG. 4 shows an exemplary artificial neural network that may be used to implement one or more embodiments;

FIG. 5 shows a convolutional neural network that may be used to implement one or more embodiments;

FIG. 6 shows a data flow diagram of a generative adversarial network that may be used to implement one or more embodiments;

FIG. 7 shows a schematic structure of a recurrent machine learning model that may be used to implement one or more embodiments; and

FIG. 8 shows a high-level block diagram of a computer that may be used to implement one or more embodiments.

### DETAILED DESCRIPTION

The present invention generally relates to methods and systems for medical imaging analysis using a flexible transformer for multiple heterogeneous image input. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system. Further, reference herein to pixels of an image may refer equally to voxels of an image and vice versa.

Embodiments described herein provide for a novel flexible transformer architecture designed to effectively manage multiple anisotropic input medical images acquired at different acquisition orientations. The transformer architecture eliminates the necessity for extensive resampling or resizing the input medical images, thereby preserving the integrity of the images and preventing loss of information. By circumventing the preprocessing steps for resampling or resizing, the transformer architecture optimizes the performance and robustness of deep learning models specifically tailored for performing medical imaging analysis tasks.

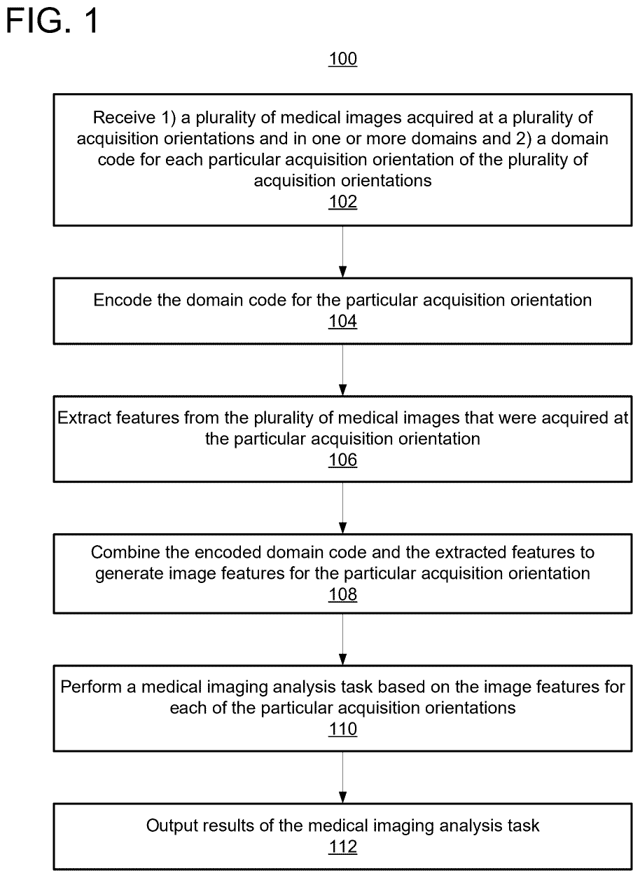

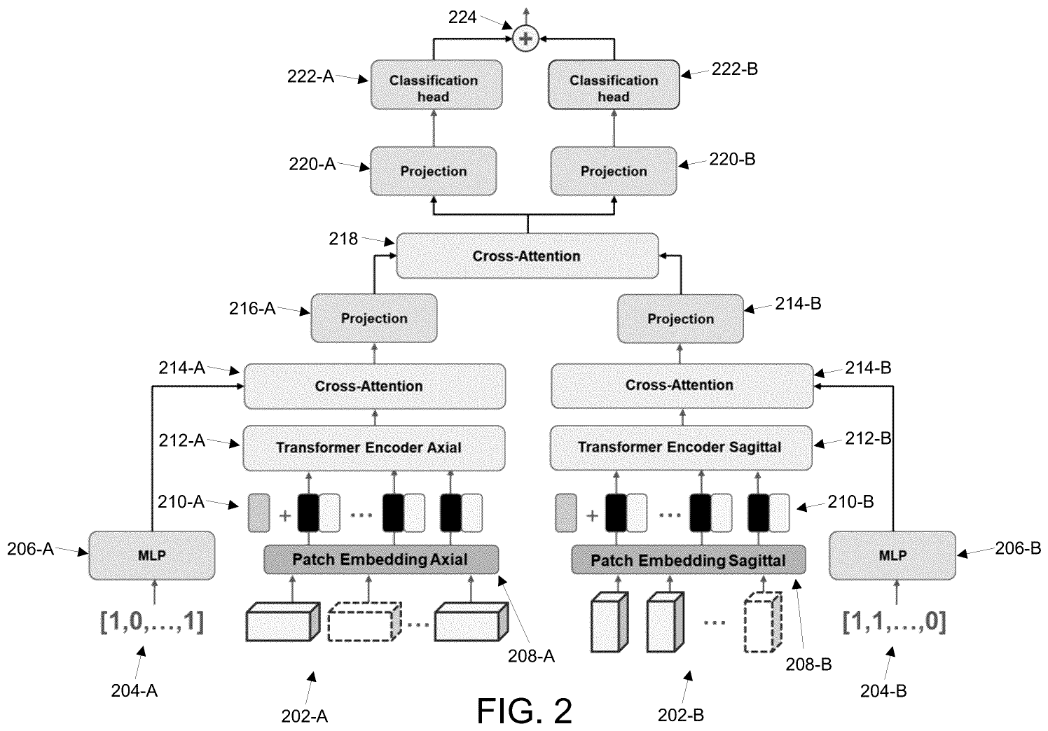

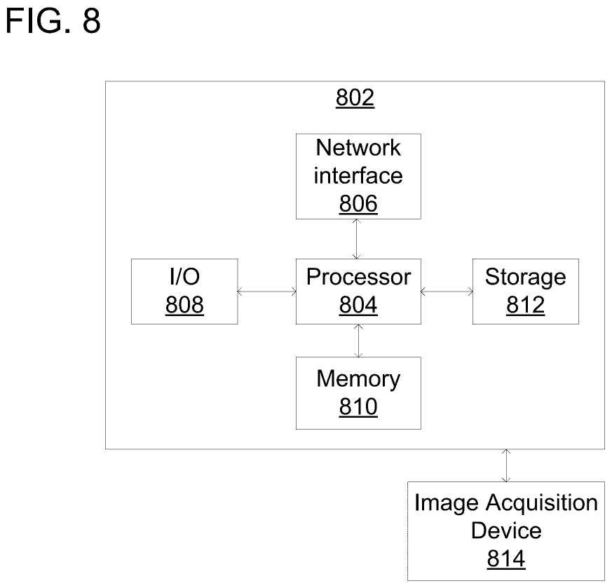

FIG. 1 shows a method 100 for performing a medical imaging analysis task on a plurality of medical images acquired at a plurality of acquisition orientations, in accordance with one or more embodiments. The steps and sub-steps of method 100 may be performed by one or more suitable computing devices, such as, e.g., computer 802 of FIG. 8. FIG. 2 shows a network architecture 200 of a transformer for performing a medical imaging analysis task on a plurality of medical images acquired at a plurality of acquisition orientations, in accordance with one or more embodiments. FIG. 1 and FIG. 2 will be described together.

At step 102 of FIG. 1, 1) a plurality of medical images acquired at a plurality of acquisition orientations and in one or more domains and 2) a domain code for each particular acquisition orientation of the plurality of acquisition orientations are received. Each of the domain codes identify a presence of the one or more domains of the plurality of medical images that were acquired at the particular acquisition orientation. In one example, as shown in network architecture 200 of FIG. 2, the plurality of medical images may be 3D medical images 202-A acquired at an axial orientation of a patient and medical images 202-B acquired at a sagittal orientation of the patient and the domain codes may be domain code 204-A identifying one or more domains of medical images 202-A and domain code 204-B identifying one or more domains of medical images 202-B (medical images 202-A and 202-B are collectively referred to as medical images 202 and domain codes 204-A and 204-B are collectively referred to as domain codes 204).

The plurality of medical images may depict any anatomical object of interest of a patient at the plurality of acquisition orientations. The plurality of acquisition orientations may comprise, for example, axial, sagittal, coronal, or any other suitable acquisition orientation of the patient. As used herein, a domain of a medical image refers to the modality of the medical image as well as the protocol used for obtaining the medical image in that modality. The modality of the one or more input medical images may include, for example, MRI (magnetic resonance imaging), CT (computed tomography), US (ultrasound), x-ray, SPECT (single-photon emission computed tomography), PET (positron emission tomography), or any other medical imaging modality or combinations of medical imaging modalities. The protocol used for obtaining the medical image may include, for example, acquisition sequences or techniques for acquiring a medical image, such as, e.g., T1-weighted, T2-weighted, proton density-weighted MRI images, contrast and non-contrast images, CT images captured with low kV (kilovoltage) and high kV, or low and high resolution medical images. Accordingly, the domains may be completely different medical imaging modalities or different image protocols within the same overall imaging modality. The plurality of medical images may be represented in the image space (e.g., as pixel or voxel values in spatial coordinates) or the latent space (e.g., as a lower-dimensional, compressed representation of the one or more medical images represented as a feature vector). The plurality of medical images in the image space may be 3D (three dimensional) volumes.

The domain code for each particular acquisition orientation identifies a presence of the one or more domains of the plurality of medical images that were acquired at the particular acquisition orientation for a set of predefined domains, or an absence of certain domains of the set of predefined domains from the one or more domains of the plurality of medical images. The set of predefined domains represents the domains that machine learning based encoders (utilized at step 106) are trained to process. The domain code may be represented in any suitable form for identifying the presence of the one or more domains in the set of predefined domains and/or the absence of the certain domains of the set of predefined domains from the one or more domains. In one embodiment, the domain codes are 1×n vectors, where n represents the number of domains in the set of predefined domains. Each position in the vector is associated with a respective domain of the set of predefined domains. The value at each position may be defined, for example, by a one-hot, where a value of 1 defines the presence of an input medical image in the associated domain and a value of 0 defines the absence of an input medical image in the associated domain. Other approaches for encoding the presence and/or absence of domains in the set of predefined domains are also contemplated.

The one or more medical images and/or the domain code may be received, for example, by directly receiving the one or more medical images from an image acquisition device (e.g., image acquisition device 814 of FIG. 8) as the one or more medical images are acquired, by loading the one or more medical images and/or the domain code from a storage or memory of a computer system (e.g., storage 812 or memory 810 of computer 802 of FIG. 8), or by receiving the one or more medical images and/or the domain code from a remote computer system (e.g., computer 802 of FIG. 8). Such a computer system or remote computer system may comprise one or more patient databases, such as, e.g., an EHR (electronic health record), EMR (electronic medical record), PHR (personal health record), HIS (health information system), RIS (radiology information system), PACS (picture archiving and communication system), LIMS (laboratory information management system), or any other suitable database or system.

Method 100 of FIG. 1 proceeds to steps 104-108, which are performed for each of the particular acquisition orientations of the plurality of acquisition orientations.

At step 104 of FIG. 1, the domain code for the particular acquisition orientation is encoded. In one embodiment, the domain code is encoded using an MLP (multilayer perceptron). For example, in one example, as shown in network architecture 200 of FIG. 2, domain codes 204-A and 204-B are respectively encoded by MLP 206-A and 206-B (collectively referred to as MLPs 206). While MLP 206-A and 206-B are separately shown in network architecture 200 to illustrate processing of domain codes 204-A and 204-B, it should be understood that MLP 206-A and 206-NB are the same MLP. The MLP receives as input the domain code for the particular acquisition orientation, transforms the domain code into features or embeddings representing a lower-dimensional, compressed representation of the domain code, and outputs the features. The domain code for the particular acquisition orientation may be encoded using any other suitable approach. For example, the domain code for the particular acquisition orientation may be encoded using a learnable linear projector that maps the domain code to the features through a set of parameters optimized during the training process.

At step 106 of FIG. 1, features are extracted from the plurality of medical images that were acquired at the particular acquisition orientation. In one embodiment, a first set of lower-level features (tokens) are extracted from the plurality of medical images that were acquired at the particular acquisition orientation and the first set of features are encoded into a second set of higher-level features.

The first set of features are extracted from the plurality of medical images that were acquired at the particular acquisition orientation using a first machine learning based encoder. The first machine learning based encoder serves as the tokenizer, and it may be, for example, a patch embedding layer, which may be implemented, for example, as a CNN (convolutional neural network). In one example, as shown in network architecture 200 of FIG. 2, features 210-A and 210-B (collectively referred to as features 210) are extracted from medical images 202-A and 202-B using patch embedding layers 208-A and 208-B (collectively referred to as patch embedding layers 208), respectively. However, the first machine learning based encoder may be implemented according to any other suitable machine learning based architecture. The first machine learning based encoder is trained to extract the first set of features from medical images acquired at the particular acquisition orientation. For example, patch embedding layer 208-A is trained to extract features from medical images acquired at an axial orientation and patch embedding layer 208-B is trained to extracted features from medical images acquired at a sagittal orientation.

The plurality of medical images that were acquired at each particular acquisition orientation are resampled onto the same pixel grid for that particular acquisition orientation to form aligned 3D images. For example, the image grid may be a (256, 256, 32) grid for medical images acquired at the axial orientation or a (256, 32, 256) grid for medical images acquired at the sagittal orientation. Then the aligned 3D images are combined (e.g., concatenated) along the channel dimension to form an input tensor for each acquisition orientation. The input tensor is divided into many 3D patches. The first machine learning based encoder receives as input the 3D patches of the plurality of medical images and generates as output the first set of features. The features of the first set of features are lower-dimensional, compressed representations of 3D patches in the 3D volumes represented as feature vectors (tokens). The first machine learning based encoder encodes the patches of the input tensor to features while capturing and encoding the most important features.

In one embodiment, the first set of features are encoded with positional embeddings (e.g., sinusoidal or learnable). The position embeddings may be fixed or trainable. For example, the position embeddings may be derived based on the spatial location of the 3D patches from which the features were extracted. Specifically, the position embedding matching ensures consistency in position embeddings across features of the different acquisition orientations. Tokens originating from features of different acquisition orientations, each representing corresponding spatial locations within differently oriented images, are paired with identical position embeddings. In one embodiment, learnable position embeddings are utilized, allowing for the dynamic adaptation of position embeddings to capture relative spatial relationships among patches from distinct branches. The learnable position embeddings enhance the ability to effectively learn and integrate information across different acquisition orientations within multi-domain medical images.

The first set of features are encoded into the second set of features using a second machine learning based encoder. The second machine learning based encoder may be a transformer encoder. In one example, as shown in network architecture 200 of FIG. 2, features 210-A and 210-B are respectively encoded into the second set of features using transformer encoder 212-A and 212-B (collectively referred to as transformer encoders 212). The second machine learning based encoder is trained to extract the second set of features from medical images acquired at the particular acquisition orientation. For example, transformer encoder 210-A is trained to extract features from medical images acquired at an axial orientation and transformer encoder 210-B is trained to extracted features from medical images acquired at a sagittal orientation. However, the second machine learning based encoder may be implemented according to any other suitable machine learning based architecture. The second machine learning based encoder receives as input the first set of features and generates as output the second set of features. Compared with the first set of features, the second set of features are higher level of features.

At step 108 of FIG. 1, the encoded domain code and the extracted features are combined to generate image features for the particular acquisition orientation. In one embodiment, the encoded domain code and the extracted features are combined using a cross-attention layer. For example, as shown in network architecture 200 of FIG. 2, the encoded domain code output from MLP 206-A and 206-B and the extracted features output by transformer encoder 212-A and 212-B are respectively combined by cross-attention layer 214-A and 214-B (collectively referred to as cross-attention layers 214). The cross-attention layer enables the encoded domain code to attend to the extracted features (or vice versa) via query, key, and value representation, which facilitates the extraction and integration of pertinent information from the encoded domain code and the extracted features.

At step 110 of FIG. 1, a medical imaging analysis task is performed based on the image features for each of the particular acquisition orientations. In one embodiment, the image features for each of the particular acquisition orientations are first combined to generate combined features for the plurality of acquisition orientations and the medical imaging analysis task is performed based on the combined features.

The image features for each of the particular acquisition orientations may be combined using projection layers and a cross-attention layer. For example, as shown in network architecture 200 of FIG. 2, the image features output by cross-attention layers 214-A and 214-B are respectively projected in a higher dimension by projections layers 216-A and 216-B (collectively referred to as projection layers 216) and the projected image features are combined by cross-attention layer 218. The cross-attention layer enables the image features for one particular acquisition orientation to attend to the image features of the other particular acquisition orientations via query, key, and value representation, which facilitates the extraction and integration of pertinent information from the particular acquisition orientations.

The medical imaging analysis task is then performed based on the combined features using a projection layer and a task specific machine learning based decoder (e.g., a transformer decoder) for each particular acquisition orientation. For example, as shown in network architecture 200 of FIG. 2, the combined features are respectively projected into a higher dimension by projection layers 220-A and 220-B (collectively referred to as projection layers 220), classification heads 222-A and 222-B (collectively referred to as classification heads 222) determine a classification based on the projected combined features, and the classifications are combined via combiner 224 to generate a final classification. Projection layers 220-A and 220-B and classification heads 222-A and 222-B are respectively trained to process the combined features from medical images acquired at the particular acquisition orientation.

In one embodiment, the medical imaging analysis task is image synthesis for generating a synthetic image from the plurality of medical images. The synthetic image may be in a domain that is absent from the one or more domains of the plurality of medical images. The medical imaging analysis task may additionally or alternatively comprise any other suitable task, such as, e.g., detection, segmentation, classification, quantification, etc.

At step 112 of FIG. 1, results of the medical imaging analysis task are output. For example, the results of the medical imaging analysis task can be output by displaying the results on a display device of a computer system (e.g., I/O 808 of computer 802 of FIG. 8), storing the results on a memory or storage of a computer system (e.g., memory 810 or storage 812 of computer 802 of FIG. 8) or by transmitting the results to a remote computer system (e.g., computer 802 of FIG. 8).

While network architecture 200 of FIG. 2 is implemented with two branches (i.e., a branch for processing medical images 202-A acquired at an axial orientation and a branch for processing medical images 202-B acquired at a sagittal orientation), it should be understood that network architecture 200 may be implemented with any number of branches for processing medical images acquired at any number of acquisition orientations. For example, in one embodiment, network architecture 200 may be implemented with three branches to process medical images acquired in axial and sagittal orientations (as shown in FIG. 2), as well as a coronal orientation.

In one embodiment, network architecture 200 may be implemented to process medical images acquired in similar orientations but at different native resolutions, e.g., to combine high-resolution structural images (e.g., T1w, T2w, FLAIR (fluid attenuated inversion recovery)) and low-resolution quantitative/metabolic/function information (e.g., DWI (diffusion-weighted imaging), fMRI (functional MRI), first-pass perfusion, MRSI (magnetic resonance spectroscopic imaging)). In this embodiment, the outputs from each branch (output from projection layers 216) are combined at cross-attention layer 218 with a two-way or three-way cross-attention. Queries are utilized from one particular branch and keys and values from the other branches are utilized to calculate the output from the particular branch providing the queries. By iteratively applying this procedure across all the branches, the outputs of each branch are obtained as the input for subsequent stages of the network for performing the medical imaging analysis task. This approach ensures comprehensive integration of information from multiple orientations or resolutions, enhancing the transformer's capacity to effectively process diverse multi-domain medical images.

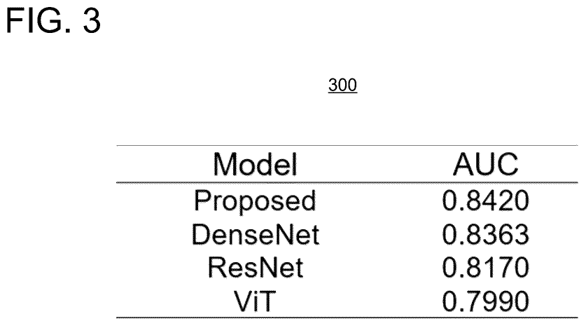

FIG. 3 shows a table 300 comparing performance of the transformer model in accordance with embodiments described herein with conventional models. Table 300 shows results on brain hemorrhage classification with multiple anisotropic MR images acquired with different acquisition orientations, including axial FLAIR, ADC (apparent diffusion coefficient), Trace, GRE (gradient echo sequences), SWI (susceptibility weighted imaging), T2, and sagittal T2 3D MR images on a testing dataset with 144 positive and 1352 negative cases. As shown in table 300, the proposed transformer model in accordance with embodiments described herein has an AUC (area under the curve) of 0.8420, outperforming DenseNet, ResNet and ViT (vision transformer).

Embodiments described herein are described with respect to the claimed systems as well as with respect to the claimed methods. Features, advantages or alternative embodiments herein can be assigned to the other claimed objects and vice versa. In other words, claims and embodiments for the systems can be improved with features described or claimed in the context of the respective methods. In this case, the functional features of the method are implemented by physical units of the system.

Furthermore, certain embodiments described herein are described with respect to methods and systems utilizing trained machine learning models, as well as with respect to methods and systems for providing trained machine learning models. Features, advantages or alternative embodiments herein can be assigned to the other claimed objects and vice versa. In other words, claims and embodiments for providing trained machine learning models can be improved with features described or claimed in the context of utilizing trained machine learning models, and vice versa. In particular, datasets used in the methods and systems for utilizing trained machine learning models can have the same properties and features as the corresponding datasets used in the methods and systems for providing trained machine learning models, and the trained machine learning models provided by the respective methods and systems can be used in the methods and systems for utilizing the trained machine learning models.

In general, a trained machine learning model mimics cognitive functions that humans associate with other human minds. In particular, by training based on training data the machine learning model is able to adapt to new circumstances and to detect and extrapolate patterns. Another term for “trained machine learning model” is “trained function.”

In general, parameters of a machine learning model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning models can be adapted iteratively by several steps of training. In particular, within the training a certain cost function can be minimized. In particular, within the training of a neural network the backpropagation algorithm can be used.

In particular, a machine learning model, such as, e.g., the MLP utilized at step 104, the first and second machine learning based encoders utilized at step 106, the cross-attention layer utilized at step 108, and/or the cross-attention layer or the machine learning based decoders utilized at step 110 of FIG. 1, or MLPs 206, patch embedding layers 208, transformer encoders 212, cross-attention layers 214, projection layers 216, cross-attention layer 218, projection layers 220, and/or classification heads 222 of FIG. 2, can comprise, for example, a neural network, a support vector machine, a decision tree and/or a Bayesian network, and/or the machine learning model can be based on, for example, k-means clustering, Q-learning, genetic algorithms and/or association rules. In particular, a neural network can be, e.g., a deep neural network, a convolutional neural network or a convolutional deep neural network. Furthermore, a neural network can be, e.g., an adversarial network, a deep adversarial network and/or a generative adversarial network.

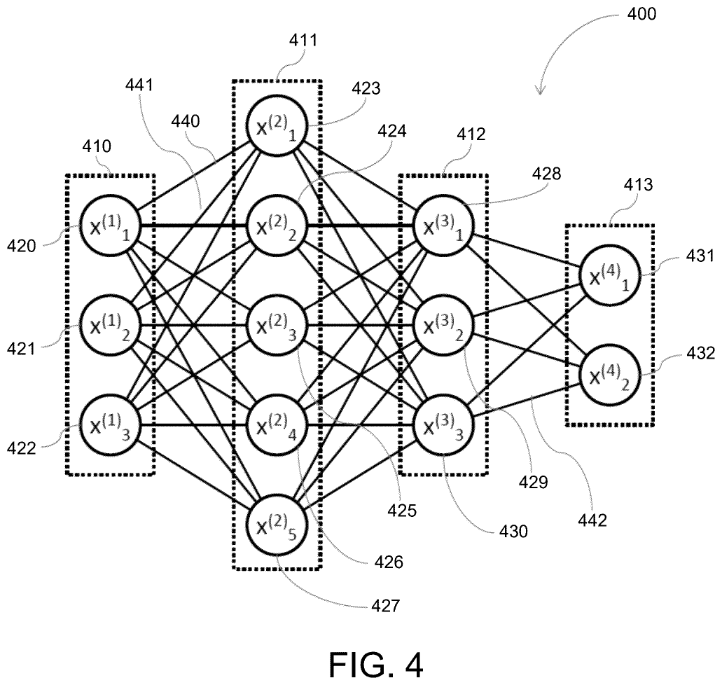

FIG. 4 shows an embodiment of an artificial neural network 400 that may be used to implement one or more machine learning models described herein. Alternative terms for “artificial neural network” are “neural network”, “artificial neural net” or “neural net”.

The artificial neural network 400 comprises nodes 420, . . . , 432 and edges 440, 442, wherein each edge 440, . . . , 442 is a directed connection from a first node 420, 432 to a second node 420, . . . , 432. In general, the first node 420, . . . , 432 and the second node 420, . . . , 432 are different nodes 420, . . . , 432, it is also possible that the first node 420, . . . , 432 and the second node 420, . . . , 432 are identical. For example, in FIG. 4 the edge 440 is a directed connection from the node 420 to the node 423, and the edge 442 is a directed connection from the node 430 to the node 432. An edge 440, . . . , 442 from a first node 420, . . . , 432 to a second node 420, . . . , 432 is also denoted as “ingoing edge” for the second node 420, . . . , 432 and as “outgoing edge” for the first node 420, . . . 432.

In this embodiment, the nodes 420, . . . , 432 of the artificial neural network 400 can be arranged in layers 410, . . . , 413, wherein the layers can comprise an intrinsic order introduced by the edges 440, . . . , 442 between the nodes 420, . . . , 432. In particular, edges 440, . . . , 442 can exist only between neighboring layers of nodes. In the displayed embodiment, there is an input layer 410 comprising only nodes 420, . . . , 422 without an incoming edge, an output layer 413 comprising only nodes 431, 432 without outgoing edges, and hidden layers 411, 412 in-between the input layer 410 and the output layer 413. In general, the number of hidden layers 411, 412 can be chosen arbitrarily. The number of nodes 420, . . . , 422 within the input layer 410 usually relates to the number of input values of the neural network, and the number of nodes 431, 432 within the output layer 413 usually relates to the number of output values of the neural network.

In particular, a (real) number can be assigned as a value to every node 420, . . . , 432 of the neural network 400. Here, x⁽ⁿ⁾^{ᵢ} denotes the value of the i-th node 420, . . . , 432 of the n-th layer 410, . . . , 413. The values of the nodes 420, . . . , 422 of the input layer 410 are equivalent to the input values of the neural network 400, the values of the nodes 431, 432 of the output layer 413 are equivalent to the output value of the neural network 400. Furthermore, each edge 440, . . . , 442 can comprise a weight being a real number, in particular, the weight is a real number within the interval [−1, 1] or within the interval [0, 1]. Here, w^{(m,n)}^{_{i,j}} denotes the weight of the edge between the i-th node 420, . . . , 432 of the m-th layer 410, . . . , 413 and the j-th node 420, . . . , 432 of the n-th layer 410, . . . , 413. Furthermore, the abbreviation w⁽ⁿ⁾^{_{i,j}} is defined for the weight w^{(n,n+1)}^{_{i,j}}.

In particular, to calculate the output values of the neural network 400, the input values are propagated through the neural network. In particular, the values of the nodes 420, . . . , 432 of the (n+1)-th layer 410, . . . , 413 can be calculated based on the values of the nodes 420, . . . , 432 of the n-th layer 410, . . . , 413 by

$${x}^{{( n + 1 )}_{j}} = f ( {\sum }_{i} {x}^{{( n )}_{i}} \cdot {w}^{{( n )}_{i , j}} ) .$$

Herein, the function f is a transfer function (another term is “activation function”). Known transfer functions are step functions, sigmoid function (e.g., the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 410 are given by the input of the neural network 400, wherein values of the first hid-den layer 411 can be calculated based on the values of the input layer 410 of the neural network, wherein values of the second hidden layer 412 can be calculated based in the values of the first hidden layer 411, etc.

In order to set the values w^{(m,n)}^{_{i,j}} for the edges, the neural network 400 has to be trained using training data. In particular, training data comprises training input data and training output data (denoted as tᵢ). For a training step, the neural network 400 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 400 (backpropagation algorithm). In particular, the weights are changed according to

$${w}^{{′ ( n )}_{i , j}} = {w}^{{( n )}_{i , j}} - γ \cdot {δ}^{{( n )}_{j}} \cdot {x}^{{( n )}_{i}}$$

wherein y is a learning rate, and the numbers δ⁽ⁿ⁾^{ⱼ} can be recursively calculated as

$${δ}^{{( n )}_{j}} = ( {\sum }_{k} {δ}^{{( n + 1 )}_{k}} \cdot {w}^{{( n + 1 )}_{j , k}} ) \cdot {f}^{′} ( {\sum }_{i} {x}^{{( n )}_{i}} \cdot {w}^{{( n )}_{i , j}} )$$

based on δ⁽ⁿ⁺¹⁾^{ⱼ}, if the (n+1)-th layer is not the output layer, and

$${δ}^{{( n )}_{j}} = ( {x}^{{( n + 1 )}_{j}} - {t}^{{( n + 1 )}_{j}} ) \cdot {f}^{′} ( {x}^{{( n )}_{i}} \cdot {w}^{{( n )}_{i , j}} )$$

if the (n+1)-th layer is the output layer 413, wherein f′ is the first derivative of the activation function, and t⁽ⁿ⁺¹⁾^{ⱼ} is the comparison training value for the j-th node of the output layer 413.

A convolutional neural network is a neural network that uses a convolution operation instead of general matrix multiplication in at least one of its layers (so-called “convolutional layer”). In particular, a convolutional layer performs a dot product of one or more convolution kernels with the convolutional layer's input data/image, wherein the entries of the one or more convolution kernels are the parameters or weights that are adapted by training. In particular, one can use the Frobenius inner product and the ReLU activation function. A convolutional neural network can comprise additional layers, e.g., pooling layers, fully connected layers, and normalization layers.

By using convolutional neural networks input images can be processed in a very efficient way, because a convolution operation based on different kernels can extract various image features, so that by adapting the weights of the convolution kernel the relevant image features can be found during training. Furthermore, based on the weight-sharing in the convolutional kernels less parameters need to be trained, which prevents overfitting in the training phase and allows to have faster training or more layers in the network, improving the performance of the network.

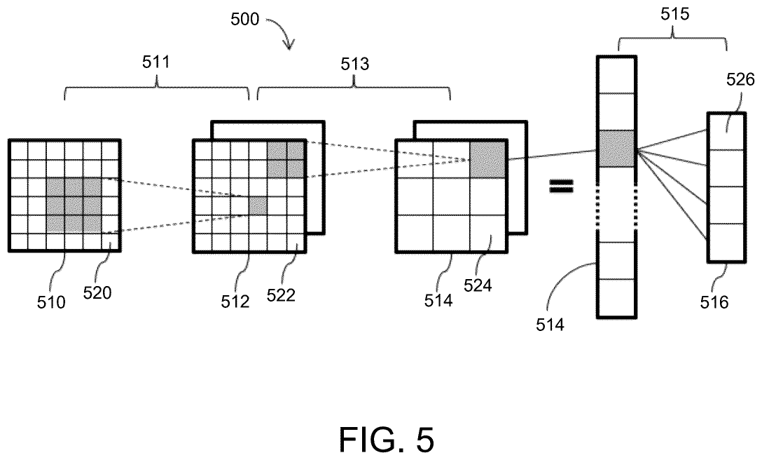

FIG. 5 shows an embodiment of a convolutional neural network 500 that may be used to implement one or more machine learning models described herein. In the displayed embodiment, the convolutional neural network 500 comprises an input node layer 510, a convolutional layer 511, a pooling layer 513, a fully connected layer 514 and an output node layer 516, as well as hidden node layers 512, 514. Alternatively, the convolutional neural network 500 can comprise several convolutional layers 511, several pooling layers 513 and several fully connected layers 515, as well as other types of layers. The order of the layers can be chosen arbitrarily, usually fully connected layers 515 are used as the last layers before the output layer 516.

In particular, within a convolutional neural network 500 nodes 520, 522, 524 of a node layer 510, 512, 514 can be considered to be arranged as a d-dimensional matrix or as a d-dimensional image. In particular, in the two-dimensional case the value of the node 520, 522, 524 indexed with i and j in the n-th node layer 510, 512, 514 can be denoted as x(n)[i, j]. However, the arrangement of the nodes 520, 522, 524 of one node layer 510, 512, 514 does not have an effect on the calculations executed within the convolutional neural network 500 as such, since these are given solely by the structure and the weights of the edges.

A convolutional layer 511 is a connection layer between an anterior node layer 510 (with node values x(n−1)) and a posterior node layer 512 (with node values x(n)). In particular, a convolutional layer 511 is characterized by the structure and the weights of the incoming edges forming a convolution operation based on a certain number of kernels. In particular, the structure and the weights of the edges of the convolutional layer 511 are chosen such that the values x(n) of the nodes 522 of the posterior node layer 512 are calculated as a convolution x(n)=K*x(n−1) based on the values x(n−1) of the nodes 520 anterior node layer 510, where the convolution * is defined in the two-dimensional case as

$${x}_{k}^{( n )} [ i , j ] = ( K * {x}^{( n - 1 )} ) [ i , j ] = {\sum }_{{i}^{′}} {\sum }_{{j}^{′}} K [ {i}^{′} , {j}^{′} ] \cdot {x}^{( n - 1 )} [ i - {i}^{′} , j - {j}^{′} ] .$$

Here the kernel K is a d-dimensional matrix (in this embodiment, a two-dimensional matrix), which is usually small compared to the number of nodes 520, 522 (e.g., a 3×3 matrix, or a 5×5 matrix). In particular, this implies that the weights of the edges in the convolution layer 511 are not independent, but chosen such that they produce said convolution equation. In particular, for a kernel being a 3×3 matrix, there are only 9 independent weights (each entry of the kernel matrix corresponding to one independent weight), irrespectively of the number of nodes 520, 522 in the anterior node layer 510 and the posterior node layer 512.

In general, convolutional neural networks 500 use node layers 510, 512, 514 with a plurality of channels, in particular, due to the use of a plurality of kernels in convolutional layers 511. In those cases, the node layers can be considered as (d+1)-dimensional matrices (the first dimension indexing the channels). The action of a convolutional layer 511 is then a two-dimensional example defined as

$${x}^{{( n )}_{b}} [ i , j ] = {\sum }_{a} {K}_{a , b} * {x}^{{( n - 1 )}_{a}} [ i , j ] = {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ]$$

where x⁽ⁿ⁻¹⁾^{ₐ} corresponds to the a-th channel of the anterior node layer 510, x⁽ⁿ⁾^{_{b}} corresponds to the b-th channel of the posterior node layer 512 and K_{a,b} corresponds to one of the kernels. If a convolutional layer 511 acts on an anterior node layer 510 with A channels and outputs a posterior node layer 512 with B channels, there are A·B independent d-dimensional kernels K_{a,b}.

In general, in convolutional neural networks 500 activation functions are used. In this embodiment ReLU (acronym for “Rectified Linear Units”) is used, with R(z)=max(0, z), so that the action of the convolutional layer 511 in the two-dimensional example is

$${x}^{{( n )}_{b}} [ i , j ] = R ( {\sum }_{a} ( {K}_{a , b} * {x}^{{( n - 1 )}_{a}} ) [ i , j ] ) = R ( {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ] )$$

It is also possible to use other activation functions, e.g., ELU (acronym for “Exponential Linear Unit”), LeakyReLU, Sigmoid, Tanh or Softmax.

In the displayed embodiment, the input layer 510 comprises 36 nodes 520, arranged as a two-dimensional 6×6 matrix. The first hidden node layer 512 comprises 72 nodes 522, arranged as two two-dimensional 6×6 matrices, each of the two matrices being the result of a convolution of the values of the input layer with a 3×3 kernel within the convolutional layer 511. Equivalently, the nodes 522 of the first hidden node layer 512 can be interpreted as arranged as a three-dimensional 2×6×6 matrix, wherein the first dimension correspond to the channel dimension.

The advantage of using convolutional layers 511 is that spatially local correlation of the input data can exploited by enforcing a local connectivity pattern between nodes of adjacent layers, in particular by each node being connected to only a small region of the nodes of the preceding layer.

A pooling layer 513 is a connection layer between an anterior node layer 512 (with node values x(n−1)) and a posterior node layer 514 (with node values x(n)). In particular, a pooling layer 513 can be characterized by the structure and the weights of the edges and the activation function forming a pooling operation based on a non-linear pooling function f. For example, in the two-dimensional case the values x(n) of the nodes 524 of the posterior node layer 514 can be calculated based on the values x(n−1) of the nodes 522 of the anterior node layer 512 as

$${x}^{{( n )}_{b}} [ i , j ] = f ( {x}^{( n - 1 )} [ {id}_{1} , {jd}_{2} ] , ... , {x}^{{( n - 1 )}_{b}} [ ( i + 1 ) {d}_{1} - 1 , ( j + 1 ) {d}_{2} - 1 ] )$$

In other words, by using a pooling layer 513 the number of nodes 522, 524 can be reduced, by re-placing a number d1·d2 of neighboring nodes 522 in the anterior node layer 512 with a single node 522 in the posterior node layer 514 being calculated as a function of the values of said number of neighboring nodes. In particular, the pooling function f can be the max-function, the average or the L2-Norm. In particular, for a pooling layer 513 the weights of the incoming edges are fixed and are not modified by training.

The advantage of using a pooling layer 513 is that the number of nodes 522, 524 and the number of parameters is reduced. This leads to the amount of computation in the network being reduced and to a control of overfitting.

In the displayed embodiment, the pooling layer 513 is a max-pooling layer, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

In general, the last layers of a convolutional neural network 500 are fully connected layers 515. A fully connected layer 515 is a connection layer between an anterior node layer 514 and a posterior node layer 516. A fully connected layer 513 can be characterized by the fact that a majority, in particular, all edges between nodes 514 of the anterior node layer 514 and the nodes 516 of the posterior node layer are present, and wherein the weight of each of these edges can be adjusted individually.

In this embodiment, the nodes 524 of the anterior node layer 514 of the fully connected layer 515 are displayed both as two-dimensional matrices, and additionally as non-related nodes (indicated as a line of nodes, wherein the number of nodes was reduced for a better presentability). This operation is also denoted as “flattening”. In this embodiment, the number of nodes 526 in the posterior node layer 516 of the fully connected layer 515 smaller than the number of nodes 524 in the anterior node layer 514. Alternatively, the number of nodes 526 can be equal or larger.

Furthermore, in this embodiment the Softmax activation function is used within the fully connected layer 515. By applying the Softmax function, the sum the values of all nodes 526 of the output layer 516 is 1, and all values of all nodes 526 of the output layer 516 are real numbers between 0 and 1. In particular, if using the convolutional neural network 500 for categorizing input data, the values of the output layer 516 can be interpreted as the probability of the input data falling into one of the different categories.

In particular, convolutional neural networks 500 can be trained based on the backpropagation algorithm. For preventing overfitting, methods of regularization can be used, e.g., dropout of nodes 520, . . . , 524, stochastic pooling, use of artificial data, weight decay based on the L1 or the L2 norm, or max norm constraints.

According to an aspect, the machine learning model may comprise one or more residual networks (ResNet). In particular, a ResNet is an artificial neural network comprising at least one jump or skip connection used to jump over at least one layer of the artificial neural network. In particular, a ResNet may be a convolutional neural network comprising one or more skip connections respectively skipping one or more convolutional layers. According to some examples, the ResNets may be represented as m-layer ResNets, where m is the number of layers in the corresponding architecture and, according to some examples, may take values of 34, 50, 101, or 152. According to some examples, such an m-layer ResNet may respectively comprise (m−2)/2 skip connections.

A skip connection may be seen as a bypass which directly feeds the output of one preceding layer over one or more bypassed layers to a layer succeeding the one or more bypassed layers. Instead of having to directly fit a desired mapping, the bypassed layers would then have to fit a residual mapping “balancing” the directly fed output.

Fitting the residual mapping is computationally easier to optimize than the directed mapping. What is more, this alleviates the problem of vanishing/exploding gradients during optimization upon training the machine learning models: if a bypassed layer runs into such problems, its contribution may be skipped by regularization of the directly fed output. Using ResNets thus brings about the advantage that much deeper networks may be trained.

A generative adversarial model (an acronym is GA model) comprises a generative function and a discriminative function, wherein the generative function creates synthetic data, and the discriminative function distinguishes between synthetic and real data. By training the generative function and/or the discriminative function on the one hand the generative function is configured to create synthetic data which is incorrectly classified by the discriminative function as real, on the other hand the discriminative function is configured to distinguish between real data and synthetic data generated by the generative function. In the notion of game theory, a generative adversarial model can be interpreted as a zero-sum game. The training of the generative function and/or of the discriminative function is based, in particular, on the minimization of a cost function.

By using a GA model, based on a set of training data synthetic data can be generated that has the same characteristics as the training data set. The training of the GA model can be based on data not being annotated (unsupervised learning), so that there is low effort in training a GA model.

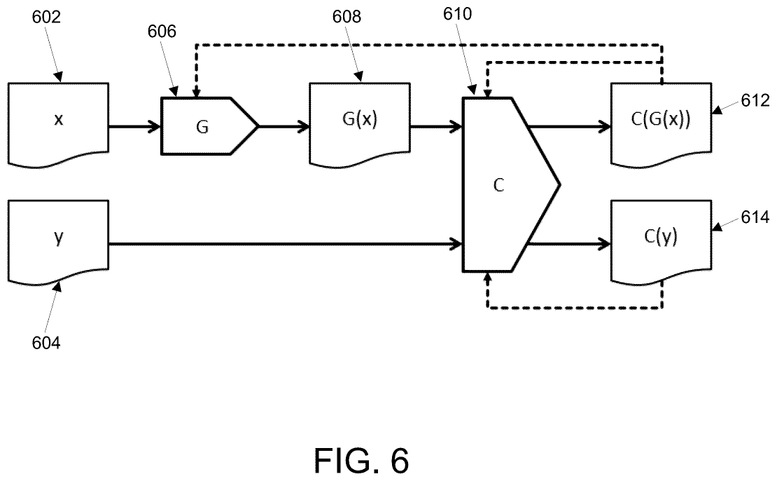

FIG. 6 shows a data flow diagram according to an embodiment for using a generative adversarial network for creating synthetic output data G(x) 608 based on input data x 602 that is indistinguishable from real output data y 604, in accordance with one or more embodiments. The synthetic output data G(x) 608 has the same structure as the real output data y 604, but its content is not derived from real world data.

The generative adversarial network comprises a generator function G 606 and a classifier function C 610 which are trained jointly. The task of the generator function G 606 is to provide realistic synthetic output data G(x) 608 based on input data x 602, and the task of the classifier function C 610 is to distinguish between real output data y 604 and synthetic output data G(x) 608. In particular, the output of the classifier function C 610 is a real number between 0 and 1 corresponding to the probability of the input value being real data, so that an ideal classifier function would calculate an output value of C(y) 614≈1 for real data y 604 and C(G(x)) 612≈0 for synthetic data G(x) 608.

Within the training process, parameters of the generator function G 606 are adapted so that the synthetic output data G(x) 608 has the same characteristics as real output data y 604, so that the classifier function C 610 cannot distinguish between real and synthetic data anymore. At the same time, parameters of the classifier function C 610 are adapted so that it distinguishes between real and synthetic data in the best possible way. Here, the training relies on pairs comprising input data x 602 and the corresponding real output data y 604. Within a single training step, the generator function G 606 is applied to the input data x 602 for generating synthetic output data G(x) 608. Furthermore, the classifier function C 610 is applied to the real output data y 604 for generating a first classification result C(y) 614. Additionally, the classifier function C 610 is applied to the synthetic output data G(x) 608 for generating a second classification result C(G(x)) 612.

Adapting the parameters of the generative function G 606 and the classifier function C 610 is based on minimizing a cost function by using the backpropagation algorithm, respectively. In this embodiment, the cost function K_{C} for the classifier function C 610 is K_{C} ∝−BCE(C(y), 1)−BCE(C(G(x)), 0), wherein BCE denotes the binary cross entropy defined as BCE(z, z′)=z′·log(z)+(1−z′)·log(1−z). By using this cost function, both wrongly classifying real output data as synthetic (indicated by C(y)≈0) and wrongly classifying synthetic output data as real (indicated as C(G(x)) 612≈1) increases the cost function K_{C} to be minimized. Furthermore, the cost function K_{G} for the generator function G 606 is K_{G} ∝−BCE(C(G(x)), 1)=−log (C(G(x)). By using this cost function, correctly classified synthetic output data (indicated as C(G(x)) 612≈0) leads to an increase of the cost function K_{G} to be minimized.

In particular, a recurrent machine learning model is a machine learning model whose output does not only depend on the input value and the parameters of the machine learning model adapted by the training process, but also on a hidden state vector, wherein the hidden state vector is based on previous inputs used on for the recurrent machine learning model. In particular, the recurrent machine learning model can comprise additional storage states or additional structures that incorporate time delays or comprise feedback loops.

In particular, the underlying structure of a recurrent machine learning model can be a neural network, which can be denoted as recurrent neural network. Such a recurrent neural network can be described as an artificial neural network where connections between nodes form a directed graph along a temporal sequence. In particular, a recurrent neural network can be interpreted as directed acyclic graph. In particular, the recurrent neural network can be a finite impulse recurrent neural network or an infinite impulse recurrent neural network (wherein a finite impulse network can be unrolled and replaced with a strictly feedforward neural network, and an infinite impulse network cannot be unrolled and replaced with a strictly feedforward neural network).

In particular, training a recurrent neural network can be based on the BPTT algorithm (acronym for “backpropagation through time”), on the RTRL algorithm (acronym for “real-time recurrent learning”) and/or on genetic algorithms.

By using a recurrent machine learning model input data comprising sequences of variable length can be used. In particular, this implies that the method cannot be used only for a fixed number of input datasets (and needs to be trained differently for every other number of input datasets used as input), but can be used for an arbitrary number of input datasets. This implies that the whole set of training data, independent of the number of input datasets contained in different sequences, can be used within the training, and that training data is not reduced to training data corresponding to a certain number of successive input datasets.

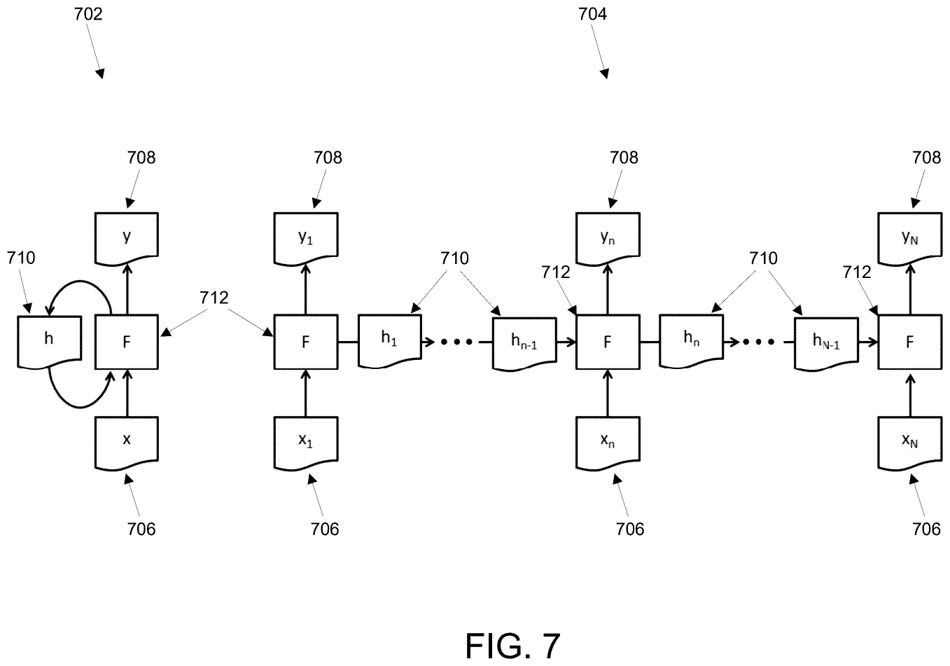

FIG. 7 shows the schematic structure of a recurrent machine learning model F, both in a recurrent representation 702 and in an unfolded representation 704, that may be used to implement one or more machine learning models described herein. The recurrent machine learning model takes as input several input datasets x, x₁, . . . , x_{N} 706 and creates a corresponding set of output datasets y, y₁, . . . , y_{N} 708. Furthermore, the output depends on a so-called hidden vector h, h₁, . . . , h_{N} 710, which implicitly comprises information about input datasets previously used as input for the recurrent machine learning model F 712. By using these hidden vectors h, h₁, . . . , h_{N} 710, a sequentiality of the input datasets can be leveraged.

In a single step of the processing, the recurrent machine learning model F 712 takes as input the hidden vector hₙ₋₁ created within the previous step and an input dataset xₙ. Within this step, the recurrent machine learning model F generates as output an updated hidden vector ha and an output dataset yₙ. In other words, one step of processing calculates (yₙ, hₙ)=F(xₙ, hₙ₋₁), or by splitting the recurrent machine learning model F 712 into a part F(y) calculating the output data and F(h) calculating the hidden vector, one step of processing calculates yₙ=F^{(y)}(xₙ, hₙ₋₁) and hₙ=F^{(h)}(xₙ, hₙ₋₁). For the first processing step, h₀ can be chosen randomly or filled with all entries being zero. The parameters of the recurrent machine learning model F 712 that were trained based on training datasets before do not change between the different processing steps.

In particular, the output data and the hidden vector of a processing step depend on all the previous input datasets used in the previous steps. yₙ=F(^{y})(xₙ, F^{(h)}(xₙ₋₁, hₙ₋₂)) and hₙ=F(h)(xₙ, F^{(h)}(xₙ₋₁, hₙ₋₂)).

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatuses, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatuses, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIG. 1 or 2. Certain steps or functions of the methods and workflows described herein, including one or more of the steps or functions of FIG. 1 or 2, may be performed by a server or by another processor in a network-based cloud-computing system. Certain steps or functions of the methods and workflows described herein, including one or more of the steps of FIG. 1 or 2, may be performed by a client computer in a network-based cloud computing system. The steps or functions of the methods and workflows described herein, including one or more of the steps of FIG. 1 or 2, may be performed by a server and/or by a client computer in a network-based cloud computing system, in any combination.

Systems, apparatuses, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIG. 1 or 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 802 that may be used to implement systems, apparatuses, and methods described herein is depicted in FIG. 8. Computer 802 includes a processor 804 operatively coupled to a data storage device 812 and a memory 810. Processor 804 controls the overall operation of computer 802 by executing computer program instructions that define such operations. The computer program instructions may be stored in data storage device 812, or other computer readable medium, and loaded into memory 810 when execution of the computer program instructions is desired. Thus, the method and workflow steps or functions of FIG. 1 or 2 can be defined by the computer program instructions stored in memory 810 and/or data storage device 812 and controlled by processor 804 executing the computer program instructions. For example, the computer program instructions can be implemented as computer executable code programmed by one skilled in the art to perform the method and workflow steps or functions of FIG. 1 or 2. Accordingly, by executing the computer program instructions, the processor 804 executes the method and workflow steps or functions of FIG. 1 or 2. Computer 802 may also include one or more network interfaces 806 for communicating with other devices via a network. Computer 802 may also include one or more input/output devices 808 that enable user interaction with computer 802 (e.g., display, keyboard, mouse, speakers, buttons, etc.).

Processor 804 may include both general and special purpose microprocessors, and may be the sole processor or one of multiple processors of computer 802. Processor 804 may include one or more central processing units (CPUs), for example. Processor 804, data storage device 812, and/or memory 810 may include, be supplemented by, or incorporated in, one or more application-specific integrated circuits (ASICs) and/or one or more field programmable gate arrays (FPGAs).

Data storage device 812 and memory 810 each include a tangible non-transitory computer readable storage medium. Data storage device 812, and memory 810, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 808 may include peripherals, such as a printer, scanner, display screen, etc. For example, input/output devices 808 may include a display device such as a cathode ray tube (CRT) or liquid crystal display (LCD) monitor for displaying information to the user, a keyboard, and a pointing device such as a mouse or a trackball by which the user can provide input to computer 802.

An image acquisition device 814 can be connected to the computer 802 to input image data (e.g., medical images) to the computer 802. It is possible to implement the image acquisition device 814 and the computer 802 as one device. It is also possible that the image acquisition device 814 and the computer 802 communicate wirelessly through a network. In a possible embodiment, the computer 802 can be located remotely with respect to the image acquisition device 814.

Any or all of the systems, apparatuses, and methods discussed herein may be implemented using one or more computers such as computer 802.

One skilled in the art will recognize that an implementation of an actual computer or computer system may have other structures and may contain other components as well, and that FIG. 8 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The following is a list of non-limiting illustrative embodiments disclosed herein:

Illustrative embodiment 1. A computer-implemented method comprising: receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation; for each of the particular acquisition orientations: encoding the domain code for the particular acquisition orientation, extracting features from the plurality of medical images that were acquired at the particular acquisition orientation, and combining the encoded domain code and the extracted features to generate image features for the particular acquisition orientation; performing a medical imaging analysis task based on the image features for each of the particular acquisition orientations; and outputting results of the medical imaging analysis task.

Illustrative embodiment 2. The computer-implemented method of illustrative embodiment 1, wherein extracting features from the plurality of medical images that were acquired at the particular acquisition orientation comprises: extracting a first set of features from the plurality of medical images that were acquired at the particular acquisition orientation using a first machine learning based encoder; and encoding the first set of features into a second set of features using a second machine learning based encoder to generate the extracted features.

Illustrative embodiment 3. The computer-implemented method of illustrative embodiment 2, wherein extracting a first set of features from the plurality of medical images that were acquired at the particular acquisition orientation using a first machine learning based encoder comprises: encoding the first set of features with positional embeddings.

Illustrative embodiment 4. The computer-implemented method of any one of illustrative embodiments 2-3, wherein the first set of features are lower level features and the second set of features are higher level features.

Illustrative embodiment 5. The computer-implemented method of any one of illustrative embodiments 2-4, wherein extracting a first set of features from the plurality of medical images that were acquired at the particular acquisition orientation using a first machine learning based encoder comprises: resampling the plurality of medical images that were acquired at the particular acquisition orientation onto a same pixel grid for that particular acquisition orientation to form aligned images; combining the aligned images to form an input tensor; and extracting the first set of features from the input tensor using the first machine learning based encoder.

Illustrative embodiment 6. The computer-implemented method of any one of illustrative embodiments 1-5, wherein combining the encoded domain code and the extracted features to generate image features for the particular acquisition orientation comprises: combining the encoded domain code and the extracted features using a cross-attention layer.

Illustrative embodiment 7. The computer-implemented method of any one of illustrative embodiments 1-6, wherein performing a medical imaging analysis task based on the image features for each of the particular acquisition orientations comprises: combining the image features for each of the particular acquisition orientations to generate combined features; and performing the medical imaging analysis task based on the combined features.

Illustrative embodiment 8. The computer-implemented method of any one of illustrative embodiments 1-7, wherein each of the domain codes identify an absence of certain domains of a set of predefined domains from the one or more domains of the plurality of medical images that were acquired at the particular acquisition orientation.

Illustrative embodiment 9. The computer-implemented method of any one of illustrative embodiments 1-8, wherein the plurality of acquisition orientations comprises at least one of axial, sagittal, or coronal.

Illustrative embodiment 10. An apparatus comprising: means for receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation; for each of the particular acquisition orientations: means for encoding the domain code for the particular acquisition orientation, means for extracting features from the plurality of medical images that were acquired at the particular acquisition orientation, and means for combining the encoded domain code and the extracted features to generate image features for the particular acquisition orientation; means for performing a medical imaging analysis task based on the image features for each of the particular acquisition orientations; and means for outputting results of the medical imaging analysis task.

Illustrative embodiment 11. The apparatus of illustrative embodiment 10, wherein the means for extracting features from the plurality of medical images that were acquired at the particular acquisition orientation comprises: means for extracting a first set of features from the plurality of medical images that were acquired at the particular acquisition orientation using a first machine learning based encoder; and means for encoding the first set of features into a second set of features using a second machine learning based encoder to generate the extracted features.

Illustrative embodiment 12. The apparatus of any one of illustrative embodiments 10-11, wherein the means for extracting a first set of features from the plurality of medical images that were acquired at the particular acquisition orientation using a first machine learning based encoder comprises: means for encoding the first set of features with positional embeddings.

Illustrative embodiment 13. The apparatus of any one of illustrative embodiments 10-12, wherein the first set of features are lower level features and the second set of features are higher level features.

Illustrative embodiment 14. The apparatus of any one of illustrative embodiments 10-13, wherein the means for extracting a first set of features from the plurality of medical images that were acquired at the particular acquisition orientation using a first machine learning based encoder comprises: means for resampling the plurality of medical images that were acquired at the particular acquisition orientation onto a same pixel grid for that particular acquisition orientation to form aligned images; means for combining the aligned images to form an input tensor; and means for extracting the first set of features from the input tensor using the first machine learning based encoder.

Illustrative embodiment 15. A non-transitory computer-readable storage medium comprising instructions which, when executed by a computer, cause the computer to carry out operations comprising: receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation; for each of the particular acquisition orientations: encoding the domain code for the particular acquisition orientation, extracting features from the plurality of medical images that were acquired at the particular acquisition orientation, and combining the encoded domain code and the extracted features to generate image features for the particular acquisition orientation; performing a medical imaging analysis task based on the image features for each of the particular acquisition orientations; and outputting results of the medical imaging analysis task.

Illustrative embodiment 16. The non-transitory computer-readable storage medium of illustrative embodiment 15, wherein extracting features from the plurality of medical images that were acquired at the particular acquisition orientation comprises: extracting a first set of features from the plurality of medical images that were acquired at the particular acquisition orientation using a first machine learning based encoder; and encoding the first set of features into a second set of features using a second machine learning based encoder to generate the extracted features.

Illustrative embodiment 17. The non-transitory computer-readable storage medium of any one of illustrative embodiments 15-16, wherein combining the encoded domain code and the extracted features to generate image features for the particular acquisition orientation comprises: combining the encoded domain code and the extracted features using a cross-attention layer.

Illustrative embodiment 18. The non-transitory computer-readable storage medium of any one of illustrative embodiments 15-17, wherein performing a medical imaging analysis task based on the image features for each of the particular acquisition orientations comprises: combining the image features for each of the particular acquisition orientations to generate combined features; and performing the medical imaging analysis task based on the combined features.

Illustrative embodiment 19. The non-transitory computer-readable storage medium of any one of illustrative embodiments 15-18, wherein each of the domain codes identify an absence of certain domains of a set of predefined domains from the one or more domains of the plurality of medical images that were acquired at the particular acquisition orientation.

Illustrative embodiment 20. The non-transitory computer-readable storage medium of any one of illustrative embodiments 15-19, wherein the plurality of acquisition orientations comprises at least one of axial, sagittal, or coronal.

1. A computer-implemented method comprising:
receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation;
for each of the particular acquisition orientations:
encoding the domain code for the particular acquisition orientation,
extracting features from the plurality of medical images that were acquired at the particular acquisition orientation, and
combining the encoded domain code and the extracted features to generate image features for the particular acquisition orientation;
performing a medical imaging analysis task based on the image features for each of the particular acquisition orientations; and
outputting results of the medical imaging analysis task.

2. The computer-implemented method of claim 1, wherein extracting features from the plurality of medical images that were acquired at the particular acquisition orientation comprises:
extracting a first set of features from the plurality of medical images that were acquired at the particular acquisition orientation using a first machine learning based encoder; and
encoding the first set of features into a second set of features using a second machine learning based encoder to generate the extracted features.

3. The computer-implemented method of claim 2, wherein extracting a first set of features from the plurality of medical images that were acquired at the particular acquisition orientation using a first machine learning based encoder comprises:
encoding the first set of features with positional embeddings.

4. The computer-implemented method of claim 2, wherein the first set of features are lower level features and the second set of features are higher level features.

5. The computer-implemented method of claim 2, wherein extracting a first set of features from the plurality of medical images that were acquired at the particular acquisition orientation using a first machine learning based encoder comprises:
resampling the plurality of medical images that were acquired at the particular acquisition orientation onto a same pixel grid for that particular acquisition orientation to form aligned images;
combining the aligned images to form an input tensor; and
extracting the first set of features from the input tensor using the first machine learning based encoder.

6. The computer-implemented method of claim 1, wherein combining the encoded domain code and the extracted features to generate image features for the particular acquisition orientation comprises:
combining the encoded domain code and the extracted features using a cross-attention layer.

7. The computer-implemented method of claim 1, wherein performing a medical imaging analysis task based on the image features for each of the particular acquisition orientations comprises:
combining the image features for each of the particular acquisition orientations to generate combined features; and
performing the medical imaging analysis task based on the combined features.

8. The computer-implemented method of claim 1, wherein each of the domain codes identify an absence of certain domains of a set of predefined domains from the one or more domains of the plurality of medical images that were acquired at the particular acquisition orientation.

9. The computer-implemented method of claim 1, wherein the plurality of acquisition orientations comprises at least one of axial, sagittal, or coronal.

10. An apparatus comprising:
means for receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation;
for each of the particular acquisition orientations:
means for encoding the domain code for the particular acquisition orientation,
means for extracting features from the plurality of medical images that were acquired at the particular acquisition orientation, and
means for combining the encoded domain code and the extracted features to generate image features for the particular acquisition orientation;
means for performing a medical imaging analysis task based on the image features for each of the particular acquisition orientations; and
means for outputting results of the medical imaging analysis task.

11. The apparatus of claim 10, wherein the means for extracting features from the plurality of medical images that were acquired at the particular acquisition orientation comprises:
means for extracting a first set of features from the plurality of medical images that were acquired at the particular acquisition orientation using a first machine learning based encoder; and
means for encoding the first set of features into a second set of features using a second machine learning based encoder to generate the extracted features.

12. The apparatus of claim 11, wherein the means for extracting a first set of features from the plurality of medical images that were acquired at the particular acquisition orientation using a first machine learning based encoder comprises:
means for encoding the first set of features with positional embeddings.

13. The apparatus of claim 11, wherein the first set of features are lower level features and the second set of features are higher level features.

14. The apparatus of claim 11, wherein the means for extracting a first set of features from the plurality of medical images that were acquired at the particular acquisition orientation using a first machine learning based encoder comprises:
means for resampling the plurality of medical images that were acquired at the particular acquisition orientation onto a same pixel grid for that particular acquisition orientation to form aligned images;
means for combining the aligned images to form an input tensor; and
means for extracting the first set of features from the input tensor using the first machine learning based encoder.

15. A non-transitory computer-readable storage medium comprising instructions which, when executed by a computer, cause the computer to carry out operations comprising:
receiving 1) a plurality of medical images acquired at a plurality of acquisition orientations and in one or more domains and 2) a domain code for each particular acquisition orientation of the plurality of acquisition orientations, each of the domain codes identifying a presence of the one or more domains of the plurality of medical images that were acquired at the particular acquisition orientation;
for each of the particular acquisition orientations:
encoding the domain code for the particular acquisition orientation,
extracting features from the plurality of medical images that were acquired at the particular acquisition orientation, and
combining the encoded domain code and the extracted features to generate image features for the particular acquisition orientation;
performing a medical imaging analysis task based on the image features for each of the particular acquisition orientations; and
outputting results of the medical imaging analysis task.

16. The non-transitory computer-readable storage medium of claim 15, wherein extracting features from the plurality of medical images that were acquired at the particular acquisition orientation comprises:
extracting a first set of features from the plurality of medical images that were acquired at the particular acquisition orientation using a first machine learning based encoder; and
encoding the first set of features into a second set of features using a second machine learning based encoder to generate the extracted features.

17. The non-transitory computer-readable storage medium of claim 15, wherein combining the encoded domain code and the extracted features to generate image features for the particular acquisition orientation comprises:
combining the encoded domain code and the extracted features using a cross-attention layer.

18. The non-transitory computer-readable storage medium of claim 15, wherein performing a medical imaging analysis task based on the image features for each of the particular acquisition orientations comprises:
combining the image features for each of the particular acquisition orientations to generate combined features; and
performing the medical imaging analysis task based on the combined features.

19. The non-transitory computer-readable storage medium of claim 15, wherein each of the domain codes identify an absence of certain domains of a set of predefined domains from the one or more domains of the plurality of medical images that were acquired at the particular acquisition orientation.

20. The non-transitory computer-readable storage medium of claim 15, wherein the plurality of acquisition orientations comprises at least one of axial, sagittal, or coronal.
